(19) United States
(12) Patent Application Publication
(10) Pub. No.: US 2012/0300045 A1
(43) Pub. Date: Nov. 29, 2012

(54) PROJECTION APPARATUS, DECODER, AND IMAGE PROCESSING METHOD FOR THE PROJECTION APPARATUS

(75) Inventors: Yau-Wing Chung, New Taipei City (TW); Yi-Chun Lu, New Taipei City (TW)

(73) Assignee: OPTOMA CORPORATION, New Taipei City (TW)

(21) Appl. No.: 13/114,054

(22) Filed: May 24, 2011

(51) Int. Cl. H04N 13/04

(52) U.S. Cl. 348/54; 348/E13.026

(57) ABSTRACT

A projection apparatus, decoder, and an image processing method for the projection apparatus are provided therein. The projection apparatus includes a projection module, a decoder, and an optical device. The projection module is used for alternately projecting first projected images and second projected images according to a three-dimensional video signal. The decoder is coupled to the projection module, and used for receiving and decoding the three-dimensional video signal to generate and wirelessly transmit a status signal. The optical device is used for receiving a frame switching control signal outputted from the projection module, used for receiving the status signal from the decoder, and use for receiving the first projected images and the second projected images in an image receiving status.

### BACKGROUND OF THE INVENTION

1. Field of Invention

The invention is related to a projection apparatus, a decoder and an image processing method thereof, and more specifically, to a three-dimensional (3D) projection apparatus, a decoder and an image processing method thereof.

2. Description of Related Art

Conventionally, three-dimensional (3D) images would be visualized by human eyes if left and right image frames were alternately displayed in a quick succession and the active shutter glasses are turning on and off synchronously, such that the left eye only sees the left images and the right eye only sees the right images. To make the three-dimensional display working faultlessly, the video source, displayed images and active shutter glasses must be synchronized. For traditional interlaced signal such as PAL or NTSC video signal, the synchronization between the video source and displayed images would easily be accomplished by assigning the even field images for one eye and the odd field images for the other eye. However, this convenience is not available for more advanced signals such as progressive signals. Newer video standards such as High-definition Multimedia Interface (HDMI) 1.4 or DisplayPort 1.2 do support numerous methods to synchronize a high resolution video such that the video source and the displayed images would be synchronized. However, both of the video standards require additional hardware and firmware to decode and synchronize the video source with the displayed images, and such hardware is not available to millions of display devices, which have existed in the market and are capable of displaying the progressive signals. Furthermore, such hardware does increase the cost of the display device, and such hardware is not necessary for every application of display.

In U.S. Pat. No. 5,821,989 and U.S. Pat. No. 6,456,432, Lazzaro et al. disclose systems and methods of viewing pairs of perspective images of three-dimensional objects displayed from a CRT display surface in a time-multiplexed or field-sequential manner. According to the methods disclosed by Lazzaro et al., control signals are generated to synchronously change the optical state of liquid crystal (LC) shutter panels through which the time-multiplexed perspective images would be sequentially viewed in a substantially flicker-free manner by the left and right eyes of a human viewer.

Another commonly used technology for transmitting sync information from the projector to the three-dimensional active shutter glasses is DLP Link, which is developed by Texas Instrument Inc. The sync information of DLP Link is hidden in between the projected images and would be sensed by an optical sensor, such that the synchronization of the active shutter glasses with the projected images would be handled based on the sync information sensed by the optical sensor. However, if the projector, the video source and the active shutter glasses would not synchronize with each others, the active shutter glasses may not operate correctly. For example, the projected images are seen by the user via the wrong side active shutter glasses. That is, the left images are seen via the right active shutter glass, and the right images are seen via the left active shutter glass. Another limitation of conventional DLP Link shutter synchronization method is depending on the display brightness and angle of the active shutter glasses with respect to the projected images (or the screen). If the DLP Link shutter glasses operate too far away from the screen, the sync information hidden in between the projected images may be not sensed correctly, such that the DLP Link shutter glasses would fail to synchronize with the projected images.

### SUMMARY OF THE INVENTION

Accordingly, the invention is to provide a projection apparatus, a decoder, and an image processing method for the projection apparatus. An optical device (e.g. active shutter glasses) of the projection apparatus is synchronized with projected images projected from a projection module of the projection apparatus, and the optical device is capable of operating correctly even if the optical device is located far away from a screen.

Additional aspects and advantages of the invention will be set forth in the description of the techniques disclosed in the invention.

To achieve one of or all aforementioned and other advantages, an embodiment of the invention provides a projection apparatus. The projection apparatus comprises a projection module, a decoder, and an optical device. The projection module is used to alternately project first projected images and second projected images according to a three-dimensional video signal. The decoder is coupled to the projection module and used to receive and decode the three-dimensional video signal to generate and wirelessly transmit a status signal. The optical device is used to receive a frame switching control signal outputted from the projection module, receive the status signal from the decoder, and receive the first projected images and the second projected images in an image receiving status. On the other hand, the optical device may be used to receive the status signal directly from the decoder in one embodiment. In addition, the optical device may turn the image receiving status to an updated image receiving status according to the frame switching control signal and the status signal in another embodiment.

An embodiment of the invention provides a decoder. The decoder is coupled to a projection module. The projection module is used for alternately projecting first projected images and second projected images to an optical device according to a three-dimensional video signal and used for outputting a frame switching control signal to the optical device. The decoder comprises a decoding circuit and an infrared transmitter. The decoding circuit is used for receiving and decoding the three-dimensional video signal to generate a status signal. The infrared transmitter is coupled to the decoding circuit and used for transmitting the status signal to the optical device. The first projected images and the second projected images are transmitted to the optical device in an image receiving status, and the optical device turns the image receiving status to an updated image receiving status according to the frame switching control signal and the status signal.

An embodiment of the invention provides an image processing method for a projection apparatus. The image processing method comprises alternately projecting first projected images and second projected images from a projection module according to a three-dimensional video signal. The image processing method further comprises receiving and decoding the three-dimensional video signal within a decoder to generate and wirelessly transmit a status signal. The image processing method further comprises transmitting a frame switching control signal and the status signal to an optical device. The image processing method further comprises transmitting the first projected images and the second projected images to the optical device in an image receiving status. And the image processing method further comprises turning the image receiving status to an updated image receiving status according to the frame switching control signal and the status signal.

In an embodiment of the invention, the decoder generates the status signal in a predetermined period, and an elapsed time of the status signal is less than the predetermined period.

In an embodiment of the invention, the first projected images and the second projected images alternately pass through the optical device. When the optical device is in the updated image receiving status, all of the first projected images pass through a first optical unit of the optical device and all of the second projected images pass through a second optical unit of the optical device.

In an embodiment of the invention, the first projected images and the second projected images alternately pass through the optical device. When at least a part of the first projected images pass through a second optical unit of the optical device and at least a part of the second projected images pass through a first optical unit of the optical device in the image receiving status, the optical device turns the image receiving status to the updated image receiving status.

In an embodiment of the invention, the optical device is liquid crystal shutter glasses.

In an embodiment of the invention, the decoder comprises an infrared transmitter for transmitting the status signal to the optical device.

In an embodiment of the invention, the optical device comprises an infrared receiver for receiving the status signal from the infrared transmitter.

In an embodiment of the invention, the three-dimensional video signal is compatible with High-definition Multimedia Interface (HDMI) 1.4 standard.

In an embodiment of the invention, the three-dimensional video signal is compatible with DisplayPort 1.2 standard.

In order to make the aforementioned and other objects, features and advantages of the invention comprehensible, several preferred embodiments accompanied with figures are described in detail below.

Other objectives, features and advantages of the invention will be further understood from the further technological features disclosed by the embodiments of the invention wherein there are shown and described preferred embodiments of invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a projection apparatus according to an embodiment of the invention.

FIG. 2 shows the sequence of three-dimensional (3D) projected images in FIG. 1.

FIG. 3 is a timing diagram of the status signal shown in FIG. 1.

FIG. 4 is a flow chart of a method for controlling the operations of the projection apparatus according to an embodiment of the invention.

FIG. 5 is a schematic diagram of the projection apparatus shown in FIG. 1.

FIG. 6 is a functional block diagram of a projection apparatus of an embodiment of the invention.

FIG. 7 is a schematic diagram of the projection apparatus shown in FIG. 6.

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

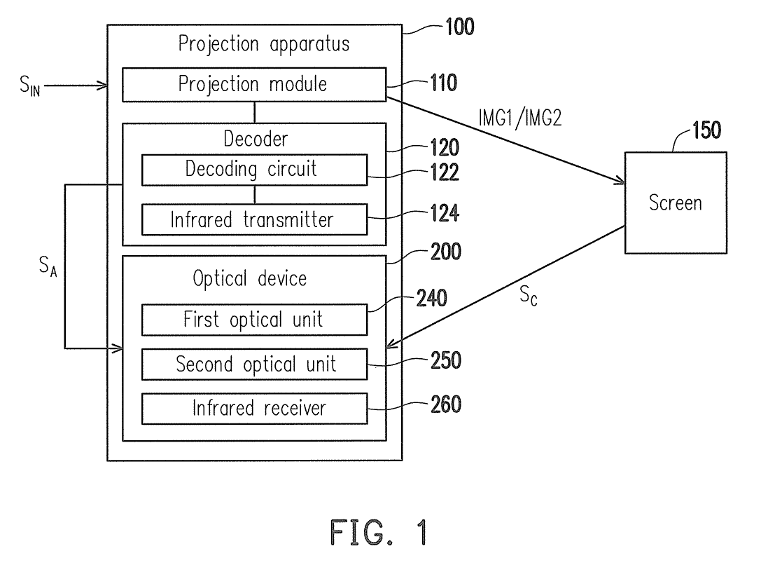

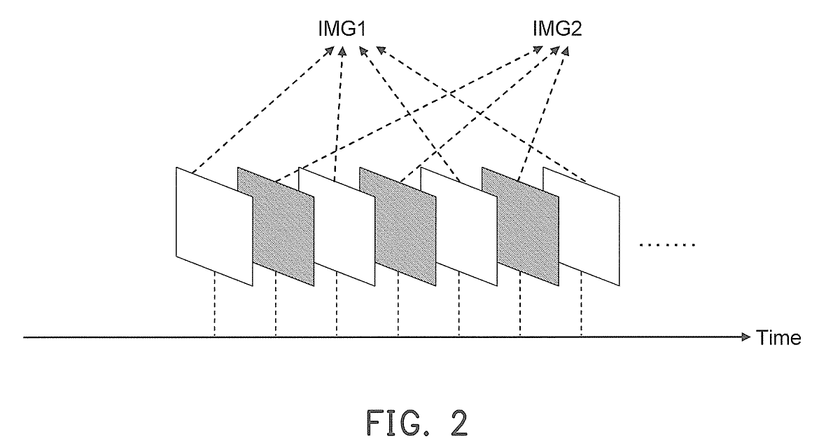

Referring to FIGS. 1 and 2, in the embodiment, the projection apparatus 100 is a Digital Light Processing (DLP) projection apparatus capable of projecting three-dimensional images, and the three-dimensional images may be visualized by human eyes through active shutter glasses. The projection apparatus 100 receives a three-dimensional video signal S_{IN} and has a projection module 110, a decoder 120, and an optical device 200. The decoder 120 is coupled to the projection module 110. The projection module 110 alternately projects first projected images IMG1 and second projected images IMG2 on a screen 150 according to the received three-dimensional video signal S_{IN}. In an embodiment of the invention, the three-dimensional video signal S_{IN} is compatible with High-definition Multimedia Interface (HDMI) 1.4 standard. In another embodiment of the invention, the three-dimensional video signal S_{IN} is compatible with DisplayPort 1.2 standard. However, the invention is not limited thereto.

The user may wear the optical device 200 to observe three-dimensional images formed by the first projected images IMG1 and the second projected images IMG2. The first projected images IMG1 are prepared for the vision of one eye of the user, and the second projected images IMG2 are prepared for the vision of the other eye of the user. As shown in FIG. 1, when the optical device 200 is in an image receiving status so that the optical device 200 may receive the first projected images IMG1 and the second projected images IMG2 from the projection module 110 through the screen 150. As shown in FIG. 2, the first projected images IMG1 and the second projected images IMG2 are alternately displayed. In the embodiment, the first projected images IMG1 would be filtered out by a second optical unit 250 of the optical device 210, and the second projected images IMG2 would be filtered out by a first optical unit 240 of the optical device 210. Therefore, the light of the first projected images IMG1 only pass through the first optical device 240, and the light of the second projected images IMG2 only pass through the second optical device 250. In other words, the first projected images IMG1 and the second projected images IMG2 alternately pass through the optical device 200.

In an embodiment of the invention, the first optical unit 240 and the second optical unit 250 are liquid crystal shutter glasses. Liquid crystal shutter glasses (also called LC shutter glasses or active shutter glasses) are glasses used in conjunction with a display screen (e.g. the screen 150) to create the illusion of a three-dimensional image, an example of stereoscopy. Each eye's glass contains a liquid crystal layer, and each glass has the property of becoming dark or transparent alternately. The first optical unit 240 and the second optical unit 250 are controlled by a DLP Link timing signal that allows the first optical unit 240 and the second optical unit 250 to alternately darken to filter out the corresponding projected images. Meanwhile, the display alternately displays different perspectives for each eye, using a technique called Alternate-frame sequencing, which achieves the desired effect of each eye seeing the intended image.

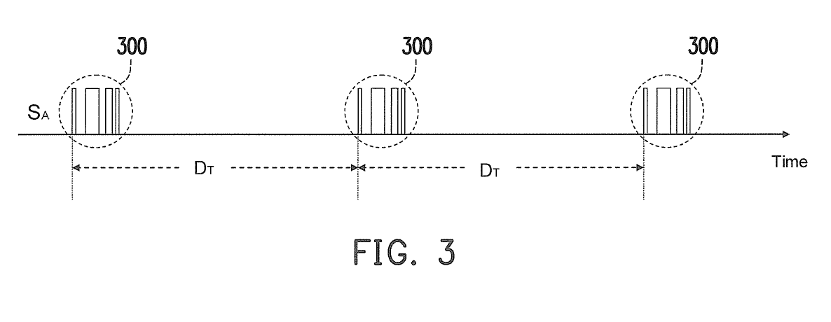

The decoder 120 receives and decodes the three-dimensional video signal S_{IN} to generate and wirelessly transmit a status signal S_{A}. The optical device 200 receives the status signal S_{A} from the decoder 120. In an embodiment of the invention, the decoder 120 decodes the three-dimensional video signal S_{IN} to generate the status signal S_{A} in a predetermined period. Please refer to FIG. 3, in the embodiment, the elapsed time 300 of the status signal S_{A} is generated by the decoder 120 in a predetermined period D_{T}. In the embodiment, the predetermined period D_{T} is ten seconds. However, the invention is not limited thereto. It should be noted that the predetermined period D_{T} may be duration of a pre-set length. In addition, the elapsed time 300 of the status signal S_{A} is less than the predetermined period D_{T}.

In an embodiment of the invention, the decoder 120 includes a decoding circuit 122 and an infrared transmitter 124, and the optical device 200 further includes an infrared receiver 260. Referring to FIG. 1, the decoding circuit 122 receives and decodes the three-dimensional video signal S_{IN} to generate the status signal S_{A}. The infrared transmitter 124 is coupled to the decoding circuit 122 and wirelessly transmits the status signal S_{A} to the infrared receiver 260 of the optical device 200. That is, the status signal S_{A} is an infrared signal, in an embodiment of the invention.

When the first projected images IMG1 and the second projected images IMG2 are projected on the screen 150, a frame switching control signal S_{C} outputted from the projection module 110 and reflected from the screen 150 is detected by the optical device 200. In an embodiment of the invention, the frame switching control signal S_{C} is a signal having the hidden sync information of DLP Link. In detail, the DLP Link defines that gray images are displayed briefly between the frame periods of the first projected images IMG1 and the second projected images IMG2 while the frame switching control signal S_{C} is outputted from the projection module 110. However, the invention is not limited thereto. In an embodiment, the optical device 200 may alternately turn on the first optical unit 240 to filter out the second projected image IMG2 and turn on the second optical unit 250 to filter out the first projected image IMG1 according to the frame switching control signal S_{C}, such that the one of the eyes of the user may see the first projected images IMG1 and the other eye of the user may see the second projected image IMG2 alternately.

The optical device 200 sets the statuses of the first optical unit 240 and the second optical unit 250 according to the status signal S_{A}. The statuses of the first optical unit 240 and the second optical unit 250 are used to indicate which one of the first optical unit 240 and the second optical unit 250 is set as an active optical unit. In detail, only one of the first optical unit 240 and the second optical unit 250 is turned on, and the turned-on optical unit is set as the active optical unit in advance. The optical device 200 sets the statuses of the first optical unit 240 and the second optical unit 250 according to the status signal S_{A}, such that the optical device 200 determines which one of the first optical unit 240 and the second optical unit 250 would be turned on in the predetermined period D_{T}. In other words, the statuses of the first optical unit 240 and the second optical unit 250 are reset in the predetermined period D_{T}, such that the optical device 200 is capable of setting the correct one of the first optical unit 240 and the second optical unit 250 as the active optical unit according to the status signal S_{A}. Therefore, the operations (e.g. turning on/off) of the first optical unit 240 and the second optical unit 250 are synchronized with the three-dimensional video signal S_{IN}, and error actions of the first optical unit 240 and the second optical unit 250 is avoided. Traditionally, the error actions may be turning on the two optical units (e.g. a right shutter glass and a left shutter glass) of the optical device within wrong frame periods, such that the left images are seen via the right shutter glass, and the right images are seen via the left active shutter glass. That will cause the user uncomfortable reaction.

Additionally, the optical device 200 also turns on the active optical unit according to the frame switching control signal S_{C} and inverts the statuses once the active optical unit is turned on, such that the first optical unit 240 and the second optical unit 250 are accurately set as the active optical unit alternately. Therefore, the optical device 200 turns the image receiving status to an updated image receiving status according to the frame switching control signal S_{C} and the status signal S_{A}. When the optical device 200 is in the updated image receiving status, all of the first projected images IMG1 pass through the first optical unit 240 of the optical device 200, and all of the second projected images IMG2 pass through the second optical unit 250 of the optical device 200.

In an embodiment of the invention, the optical device 200 is capable of turning the image receiving status to the updated image receiving status based on the condition of receiving the first projected images IMG1 and the second projected images IMG2. For example, when at least a part of the first projected images IMG1 pass through the second optical unit 250 of the optical device 200 and at least a part of the second projected images IMG2 pass through the first optical unit 240 of the optical device 200 in the image receiving status, the optical device 200 turns the image receiving status to the updated image receiving status. Therefore, in this embodiment, the first optical unit 240 and the second optical unit 250 are dynamically adjusted to operate correctly, that is, all of the first projected images IMG1 would pass through the first optical unit 240 of the optical device 200 and all of the second projected images IMG2 would pass through the second optical unit 250 of the optical device 200 in the updated image receiving status.

Since the optical device 200 sets the active optical unit according to the status signal S_{A} directly received from the decoder 120 rather than the frame switching control signal S_{C} from the screen 150, the optical device 200 set the active optical unit correctly even if the optical device 200 are located far away from the screen 150.

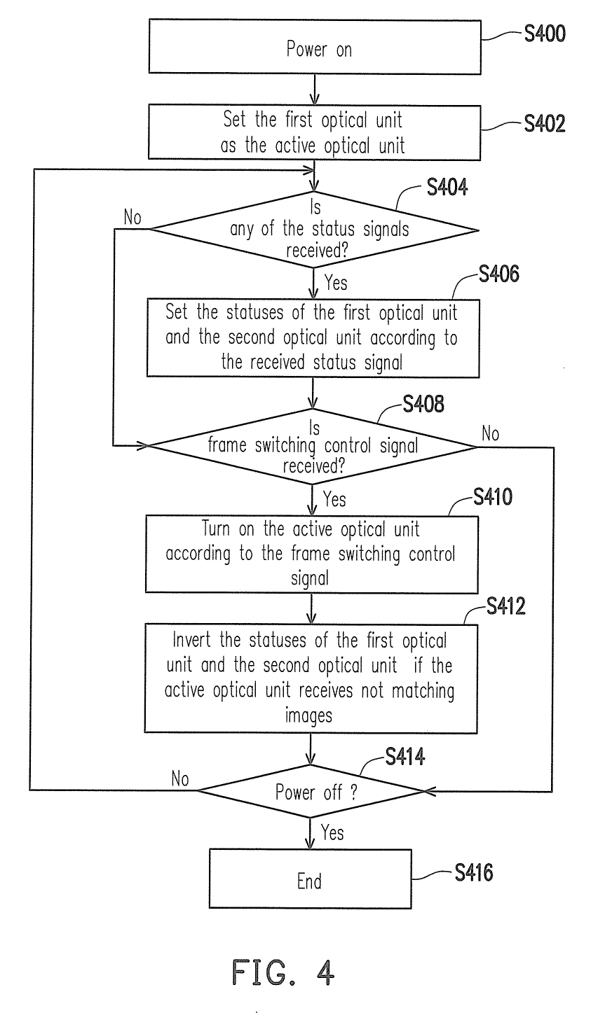

Furthermore, the method for controlling the operations of the projection apparatus includes following steps: Firstly, the three-dimensional video signal is received and decoded to generate and wirelessly transmit a status signal; then, first projected images and second projected images are alternately projected according to a three-dimensional video signal; afterwards, a frame switching control signal and the status signal are received by a optical device; thereafter, the first projected images and the second projected images are transmitted to the optical device in an image receiving status, and the image receiving status is turned to an updated image receiving status according to the frame switching control signal and the status signal. To be more specific, please refer to FIGS. 1 and 4, in step S400, the projection apparatus 100 is turned on. In step S402, the optical device 200 sets the first optical unit 240 as the active optical unit. In step S404, the optical device 200 determines whether any of the status signals S_{A} is received. If any of the status signals S_{A} is received, the optical device 200 sets the statuses of the first optical unit 240 and the second optical unit 250 according to the received status signal S_{A} in step S406. If the status signal S_{A} is not received, then step S408 is performed. In step S408, the optical device 200 determines whether the frame switching control signal S_{C} is received. If the frame switching control signal S_{C} is received, the optical device 200 turns on the active optical unit according to the frame switching control signal S_{C} in step S410, and then inverts the statuses of the first optical unit 240 and the second optical unit 250, if the active optical unit receives not matching images (step S412). If the frame switching control signal S_{C} is not received, then step S414 is performed. In step S414, the optical device 200 determines whether the projection apparatus 100 should be turned off. If the projection apparatus 100 should be turned off, then the method is terminated (step S416). Otherwise, step S404 is repeated.

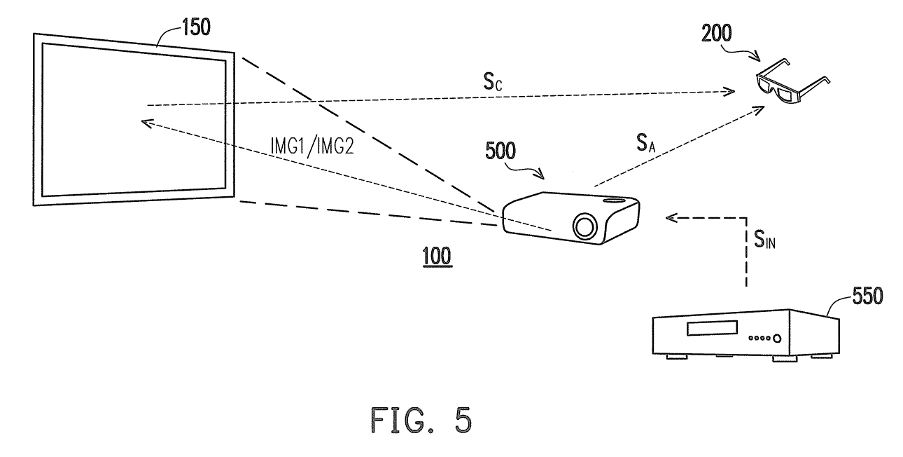

In an embodiment of invention, please refer to FIGS. 1 and 5. The projection apparatus 100 has a projector 500, and the projector 500 includes the projection module 110 and the decoder 120 shown in FIG. 1. In the embodiment, the decoder 120 is built in the projection module 110. The projector 500 receives the three-dimensional video signal S_{IN} from a video source 550. The video source 550 is, for example, a Blu-ray® player. However, it should be noted that the invention is not limited thereto.

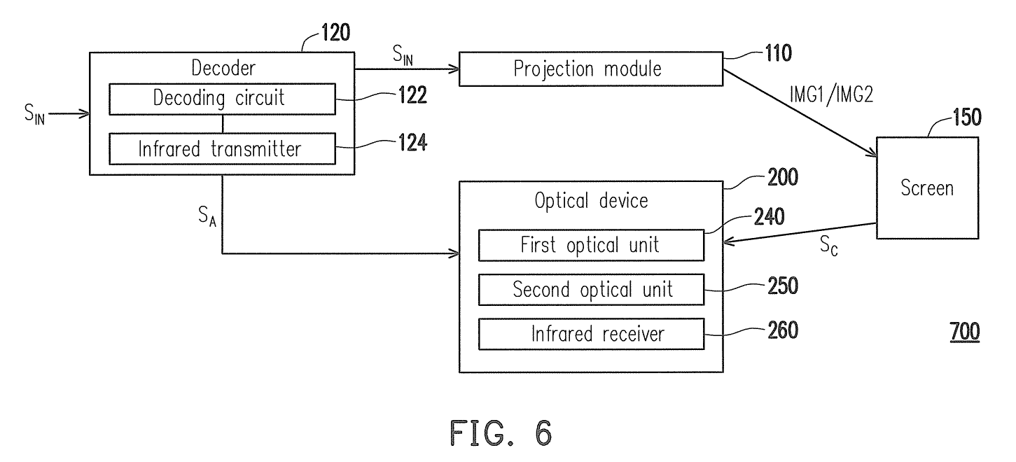

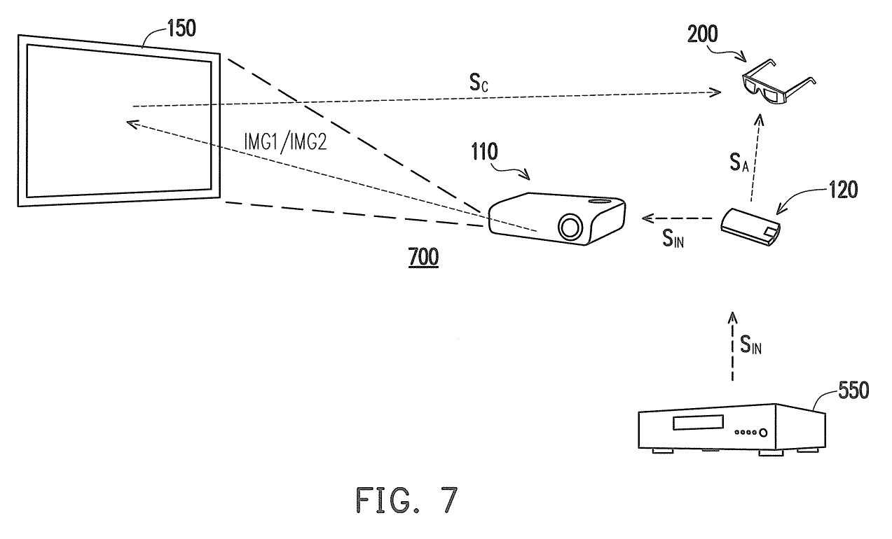

Please refer to FIGS. 6 and 7. The projection apparatus 700 has the projection module 110, the decoder 120 and the optical device 200. The major difference between the projection apparatus 100 of FIG. 1 and the projection apparatus 700 is that the decoder 120 is separated from the projection module 110. In other words, the decoder 120 is not built in the projection module 110 of the projection apparatus 700. The functions of the projection module 110, the decoder 120, and the optical device 200 of the projection apparatus 700 may be identical with those of the projection apparatus 100. For the sake of simplicity, the descriptions of the projection module 110, the decoder 120, and the optical device 200 of the projection apparatus 700 would not repeated.

In summary, the embodiments of the invention have at least one of the following advantages. The operations of the first optical unit and the second optical unit of the optical device are synchronized with the inputted three-dimensional video signal and the projected images. Therefore, traditional error actions of the first optical unit and the second optical unit would be avoided. Moreover, since it is determined which one of the first optical unit and the second optical unit would be set as an active optical unit according to the status signal rather than the hidden sync information of DLP Link, the active optical unit would be set correctly even if the two optical units of the optical device are located far away from the screen.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A projection apparatus, comprising:
a projection module, for alternately projecting first projected images and second projected images according to a three-dimensional video signal;
a decoder, coupled to the projection module, for receiving and decoding the three-dimensional video signal to generate and wirelessly transmit a status signal; and
an optical device, for receiving a frame switching control signal outputted from the projection module, for receiving the status signal from the decoder, and for receiving the first projected images and the second projected images in an image receiving status.

2. The projection apparatus as claimed in claim 1, wherein the optical device turns the image receiving status to an updated image receiving status according to the frame switching control signal and the status signal.

3. The projection apparatus as claimed in claim 1, wherein the decoder generates the status signal in a predetermined period, and an elapsed time of the status signal is less than the predetermined period.

4. The projection apparatus as claimed in claim 1, wherein the first projected images and the second projected images alternately pass through the optical device, when the optical device is in the updated image receiving status, all of the first projected images pass through a first optical unit of the optical device and all of the second projected images pass through a second optical unit of the optical device.

5. The projection apparatus as claimed in claim 1, wherein the first projected images and the second projected images alternately pass through the optical device, when at least a part of the first projected images pass through a second optical unit of the optical device and at least a part of the second projected images pass through a first optical unit of the optical device in the image receiving status, the optical device turns the image receiving status to the updated image receiving status.

6. The projection apparatus as claimed in claim 1, wherein the optical device is liquid crystal shutter glasses.

7. The projection apparatus as claimed in claim 1, wherein the decoder comprises:
an infrared transmitter, for transmitting the status signal to the optical device.

8. The projection apparatus as claimed in claim 1, wherein the optical device comprises:
an infrared receiver, for receiving the status signal.

9. The projection apparatus as claimed in claim 1, wherein the three-dimensional video signal is compatible with High-definition Multimedia Interface 1.4 standard.

10. The projection apparatus as claimed in claim 1, wherein the three-dimensional video signal is compatible with DisplayPort 1.2 standard.

11. A decoder, coupled to a projection module, wherein the projection module is used for alternately projecting first projected images and second projected images according to a three-dimensional video signal to an optical device and used for outputting a frame switching control signal to the optical device, the decoder comprising:
a decoding circuit, for receiving and decoding the three-dimensional video signal to generate a status signal; and
an infrared transmitter, coupled to the decoding circuit, for transmitting the status signal to the optical device,
wherein the first projected images and the second projected images are transmitted to the optical device in an image receiving status.

12. The decoder as claimed in claim 11, wherein the optical device turns the image receiving status to an updated image receiving status according to the frame switching control signal and the status signal.

13. The decoder as claimed in claim 12, wherein the decoder generates the status signal in a predetermined period, and an elapsed time of the status signal is less than the predetermined period.

14. An image processing method for a projection apparatus, comprising:
alternately projecting first projected images and second projected images from a projection module according to a three-dimensional video signal;
receiving and decoding the three-dimensional video signal within a decoder to generate and wirelessly transmit a status signal;
transmitting a frame switching control signal and the status signal to an optical device; and
transmitting the first projected images and the second projected images to the optical device in an image receiving status.

15. The image processing method as claimed in claim 14, further comprising turning the image receiving status to an updated image receiving status according to the frame switching control signal and the status signal.

16. The image processing method as claimed in claim 14, wherein the status signal is generated in a predetermined period, and an elapsed time of the status signal is less than the predetermined period.

17. The image processing method as claimed in claim 14, wherein the three-dimensional video signal is compatible with High-definition Multimedia Interface 1.4 standard.

18. The image processing method as claimed in claim 14, wherein the three-dimensional video signal is compatible with DisplayPort 1.2 standard.
